(19) United States
(12) Patent Application Publication
(10) Pub. No.: US 2002/0015409 A1
(43) Pub. Date: Feb. 7, 2002

(54) Broadband Ethernet video data transmission

(76) Inventors: Wei Gao, Shanghai (CN); Hong Cheng Lu, Shanghai (CN); Ming Tao Huang, Shanghai (CN); Hanzhong Gao, Germantown, MD (US)

Correspondence Address: BRIAN C. McCORMACK, BAKER & McKENZIE, SUITE 2300, 2001 ROSS AVENUE, DALLAS, TX, 75201, US

(21) Appl. No.: 09/911,080

(22) Filed: Jul. 20, 2001

(30) Foreign Application Priority Data
Jul. 20, 2000 (CN) 00 1 19491.7

(51) Int. Cl. H04L 12/56

(52) U.S. Cl. 370/394; 370/476

(57) ABSTRACT

A process is provided for broadband Ethernet to transmit digital video information in a computer communication network using means to control video orders. The transmission flow is: Video data in→buffer A→data packing and sending→broadband Ethernet→data receiving and unpacking→buffer B→video data out wherein buffer A and buffer B are used to hold temporary video data.

### RELATED APPLICATIONS

This application depends and claims priority from People's Republic of China Application No. 00119491.7 (filed Jul. 20, 2000), which is hereby incorporated by reference herein. Related applications filed concurrently herewith are U.S. Utility Application S/N ______ (filed Jul. 20, 2001) entitled “Broadband Ethernet Data Flow Control” and U.S. Utility Application S/N ______ (filed Jul. 20, 2001) entitled “Broadband Ethernet Multicasting”, which are hereby incorporated by reference herein.

### BACKGROUND OF THE INVENTION

The present invention relates to a new solution for network video data transmission, especially a solution for broadband Ethernet video data transmission, and belongs to the computer network communication field.

As Ethernet switching technology develops, the capacity of Ethernet increases drastically, which has already gone beyond the concept of traditional Local Area Networks (LAN). Broadband Ethernet is identified as 1000 mega bits per second (Mbps) fiber to the building (FTTB) and 100 Mbps Cat 5 (twisted pair) line to household. The current Ethernet video data transmission solution is to use protocols such as TCP/IP, IPX/SPX, on the foundation of Ethernet.

As they were put to use, these protocols were designed without thorough consideration of the current development of broadband Ethernet and video data transmission. Obstacles occur because of this historical lacking of consideration. For example, the length in each video data packet's head is long, lowers the effectiveness of the video data transmission. Furthermore, the IP protocols neither guarantee data packets' orders nor prevent time delay, which are sensitive for video services. Though TCP protocols can guarantee the data transmissions' orders, they will cause unnecessary data re-sending, which lowers the networks' transmission effectiveness.

### SUMMARY OF THE INVENTION

The present invention overcomes the obstacles in current technologies. One object of the invention provides a solution for network video data transmission, particularly for broadband Ethernet video data transmission resulting in increased effectiveness of video data transmission, and enhanced quality of a video picture.

This invention is a process for network video data transmission comprising the steps of:

(a) receiving video data;

(b) transmitting the video data into buffer A;

(c) packing the video data and sending to a broadband Ethernet;

(d) receiving the video data and unpacking the video data into buffer B; and

(e) transmitting the video data out;

wherein buffer A and B are used for temporary storage for video data after packing and unpacking.

### BRIEF DESCRIPTION OF THE FIGURES

FIG. 1 shows the Broadband Ethernet digital video data transmission process.

FIG. 2 shows typical Ethernet data packet frame head.

FIG. 3 shows packing process for one scene of video data.

FIG. 4 shows regrouping/sending process of video data in buffer B.

### DETAILED DESCRIPTION OF THE INVENTION

The following teachings and technical standards are incorporated herein by reference: International Electrical and Electronic Engineer, IEEE 802.3; Request for Command, RFC 793; and Moving Picture Experts Group MPEG2 ISO/IEC 13818.

According to the present invention, the process for broadband Ethernet to transmit digital video data is: video data in→buffer A→data packing and sending→broadband Ethernet→data receiving and unpacking→buffer B→video data out, wherein buffer A and B are used for temporary storage for video data after packing or unpacking. Because the differences in the demand for the definition of the picture, and different video data compressions, the data speed for digital video signals are usually between 1.5 Mbps˜5 Mbps. For video data signals, generally there are about 25 to 30 frames per second, and each frame has two scenes, reflectively, there are about 50 data scenes per second. This number of scenes may vary while using different video encoding protocol.

The time gap between each two scenes is about 20 milliseconds. Because of the characteristics of video data signals, the re-sending mechanism of the current protocols will be replaced by packet flag identifying in this invention; and timed inspection per 20 millisecond and enlarged buffer zones are used to prevent the unpredictability of the time delays. If the video data transmission speed is 8 Mbps, then the data flow DF for each frame is:

DF=8M bit/50=1M byte/50=20K byte

The maximum length for Ethernet data packet is 1518 bytes, considering the audio signal and relative information of each video data packet after unpacking, 1 k byte is taken from the transmission unit, and use 1 k byte of video signal to make the Ethernet data packet, other bytes in the packet can be used for audio signal and relative information.

Each scene of data is divided into 20 Ethernet data packet. Simple flag information is added into each data packet, and then take 1 byte as video data order flag, each flag is between 1˜20, and the order is circulated. As for different video data transmission speed, the number of packets and the range of flag for a scene may differ. The data sending/receiving terminal has a processor, which processes the flag. The following 2 byte is the flag for length, used to identify the real length of the video data in the Ethernet packet. The length after is the video data, followed by the audio data. If the audio data has a speed of 128 k bps, then for each scene, the data total is: 128 k bps/50=16 k byte/50=320 byte. Since there is no need for audio signal unpacking process, thus, the audio signal does not need a flag, but only 2 bytes of length id. The 20 packets of a scene will take the same audio data so that receiving end can take it out from any packet of this scene. After the receiving end receives the sent data of a scene, it unpacks the data packet and reads the video data directly for only once, and sends out the data after re-grouping the original data into this scene. Because the data is sent orderly by the sending end, therefore, the calculator in the sending end only needs to calculate the data packet in the order of 1˜20, write the calculated count into data order flag field of corresponding packet and reset to zero after unpacking each data scene into packets.

Because the complexity of the network structure and process, the orders of the received data may be mixed, which will effect the quality of the picture. This problem can be solved by the flag in the data packet and the calculator: if in the receiving process the flag is found mixed, then the calculator will be re-put to 1 and flags will be check, the calculating process begins again when flag 1 is found, or all packets will be dropped, and the correct scene received before will be resent to video terminal. Since the human eye has a 100 millisecond of visual persistence, therefore, one re-sending of the video data will not effect the whole picture.

Also, during the data transmission, because of the network node's store/forward mechanism, there could be a time delay between data. If the time delay between two scenes is over 20 milliseconds, then the buffer will resend the last correct data to video terminal, and the delayed scene will be ignored. If the time delay is under 20 milliseconds, then another buffer zone in buffer B will store extra data and send the data after 20 milliseconds.

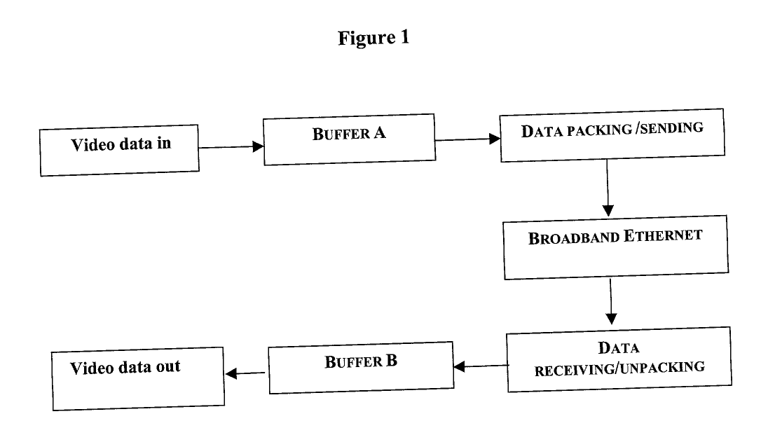

Referring to FIG. 1, the process for broadband Ethernet digital video data transmission is:

Video data in→buffer A→data packing and sending→broadband Ethernet→data receiving and unpacking→buffer B→video data out, buffer A and B are used for temporary storage for video data after packing or unpacking. However, the figure does not show the processes of video signal and data switching that are unrelated to the video data transmission, i.e. A/D, D/A switching, data compression and decompression.

The data speed for digital video signals are usually between 1.5 Mbps˜50 Mbps. For video data signals, usually there are 25-30 frames per second, and each frame has two scenes, reflectively, there are 50 data scenes per second.

The time gap between each two zones is 20 milliseconds. Because of the characteristics of video data signals, the re-sending mechanism of the current protocols will be replaced by packet flag identifying in this invention; and timed inspection per 20 millisecond and enlarged buffer zones are used to prevent the unpredictability of the time delays. If the video data transmission speed is 8 Mbps, then the data flow DF for each frame is:

DF=8M bit/50=1M byte/50=20K byte

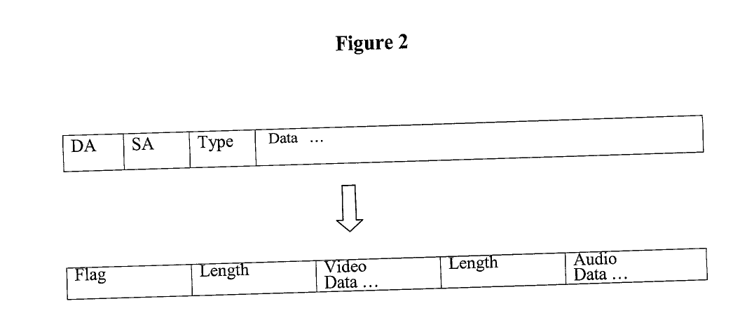

The maximum length for Ethernet data packet is 1518 byte, considering the audio signal and relative information of each video data packet after unpacking, 1 k byte is taken from the transmission unit, and use 1 k byte of video signal to make the Ethernet data packet, other bytes in the packet can be used for audio signal and relative information. Each scene of data is divided into 20 Ethernet data packet. Simple flag information is added into packets, as shown in FIG. 2. Referring to FIG. 2, DA is the destination address for 6 byte, SA is the source address for 6 byte, and type is the identification for 2 byte data type. This is typical Ethernet packet frame head structure. Each flag is between 1˜20, and the order is circulated. The data sending/receiving terminal has a processor, which processes the flag. The following 2 byte is the flag for length, used to identify the real length of the video data in the Ethernet packet. The length after is the video data, followed by the audio data. If the audio data has a speed of 128 k bps, then for each scene, the data total is: 128 k bps/50=16 k byte/50=320 byte. Since there is no need for audio signal unpacking process, thus, the audio signal does not need a flag, but only 2 bytes of length id. Because the data is sent orderly by the sending end, therefore, the calculator in the sending end only needs to calculate the data packet in the order of 1˜20, write the calculated count into data order flag field of corresponding packet and reset to zero after unpacking each data scene into packets.

Referring to FIG. 2, the packet format of a video packet is encapsulated in an Ethernet packet. The Ethernet packet head has a DA field which is 6 bytes, a SA field which is 6 bytes, a Type/Length field which is 2 bytes, and the rest of the packet is the payload which can't exceed 1518 bytes. The video data starts from the first byte of the payload. The flag field, which is 1 byte, represents the order of current packet in a scene, The 2 bytes length field that followed by the actually video data represents the length of video data. The other 2 bytes length that followed by audio data represents the length of audio data.

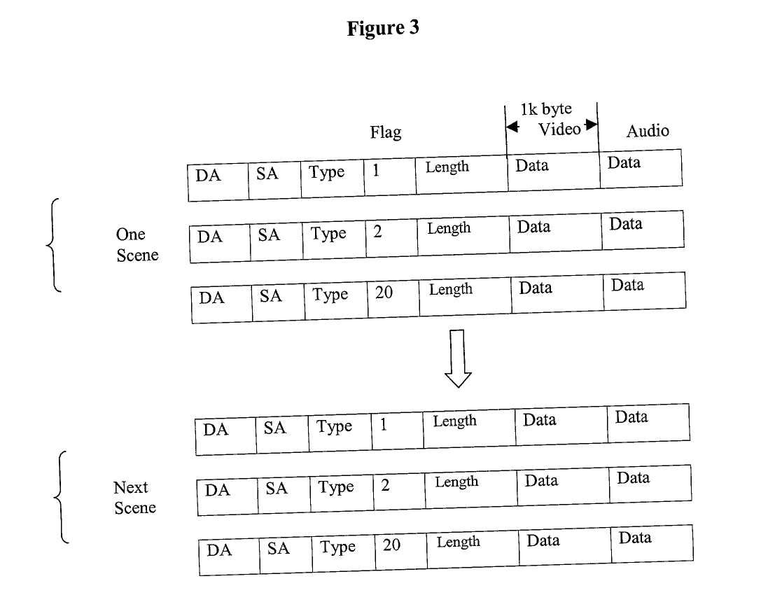

Referring to FIG. 3, the transmission order of Ethernet packets in network is shown. One scene is cut into 20 pieces and encapsulated into 20 packets, after each packet is made, the order flag will be filled into order flag field, then the 20 packets will be sent one by one. When the next scene comes, the counter will be reset to 1 to fill in the first packet of next scene. Scenes and packets are all sent one by one in order.

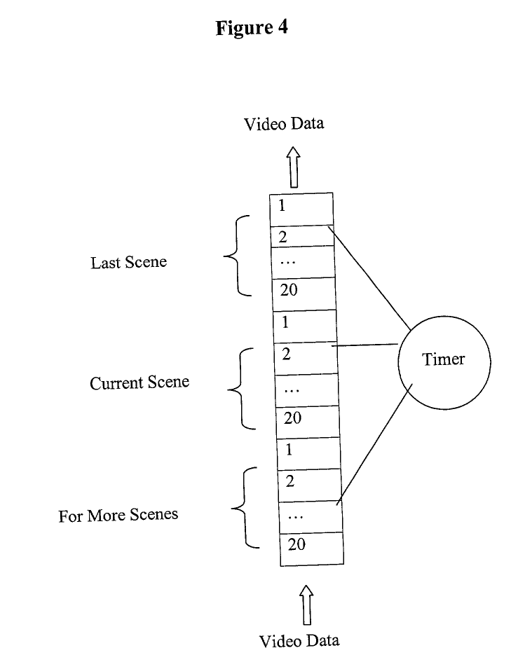

Referring to FIG. 4, the structure of Buffer A and B is shown. The buffer must be large enough to store at least three scenes of video data. There is also a timer to control the sending and receiving timing of data. When video data comes in, it will be saved in the buffer first and wait for the timer to send. If network node has a stable time delay, video data will be sent right after it arrived in buffer. If packet arrives too fast, which means that the second packets comes before the time it is supposed to arrive, it will be saved. After “Last Scene” is sent to video terminal, the timer will be set to guarantee enough time interval between scenes. If “Current Scene” comes too early, it will not be sent until timer expires. If not all the packets of “Current Scene” were received when timer expired, the “Current Scene” will be dropped, “Last Scene” will be resent to video terminal and timer will be reset to wait for next scene.

It is to be understood that while the invention has been described in conjunction with the above embodiments, that the foregoing description and the following figures are intended to illustrate and not limit the scope of the invention. Other aspects, advantages and modifications within the scope of the invention will be apparent to those skilled in the art to which the invention pertains.

What is claimed is:

1. A process for network video data transmission, comprising the steps of:
(a) receiving video data;
(b) transmitting the video data into buffer A;
(c) packing the video data and sending to a broadband Ethernet;
(d) receiving the video data and unpacking the video data into buffer B;
(e) transmitting the video data out;
wherein buffer A and B are used for temporary storage for video data after packing and unpacking.

2. The process of claim 1, wherein the process is for broadband Ethernet video data transmission.

3. A process for packet order control, comprising (a) checking a flag to guarantee data order; and (b) ignoring a mixed order instead of asking for resending.

4. A process for packet timing control, comprising absorbing unstable time delay.

5. The process of claim 3, wherein the flag of a packet is circulated in the absence of a counter.

6. The process of claim 1, wherein audio data of a scene will be copied and sent in all packets of said scene so that one correctly received packet may recover the audio information of the whole scene.

7. A process for video data control, wherein old scene will be resent to video terminal if wrong packet were received or time delay is too long.

8. The process for video data transmission of claim 1 wherein at least one buffer is used to hold data temporarily to ensure that too short time delay can be absorbed.
